(19) United States
(12) Patent Application Publication
(10) Pub. No.: US 2006/0144767 A1
(43) Pub. Date: Jul. 6, 2006

(54) Fuel filter

(75) Inventor: Andre Roesgen, Remshalden (DE)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 11/312,356

(22) Filed: Dec. 21, 2005

(30) Foreign Application Priority Data
Dec. 22, 2004 (DE) 10 2004 063 015.1

(51) Int. Cl. B01D 35/14

(52) U.S. Cl. 210/96.1; 210/112; 210/435; 210/443

(57) ABSTRACT

A fuel filter having a housing, a filter element disposed inside the housing, and an electromagnetically operable valve (50) disposed in the lower region of the fuel filter, which valve operates both an outlet (5) for discharging water and an inlet for supplying air. The valve has a single electromagnet (32) with an axially displaceable core (34) on which both a valve member (37) for the water discharge valve and a valve member (42) for the air supply valve are disposed.

### BACKGROUND OF THE INVENTION

The present invention relates to a fuel filter comprising a filter element disposed inside a housing with an inlet for unfiltered fuel, a fuel outlet for filtered fuel, and a water outlet at the bottom of the housing for discharging separated water which collects in a lower part of the housing.

U.S. Pat. No. 4,740,299 discloses a fuel filter which comprises a housing, which may be screwed onto a mounting head. A collection space is provided at the lower end of the housing, and the collection space has a manually operable valve which serves to discharge water from the fuel filter. A drawback of this fuel filter is that during manual operation of the outlet valve, there is a high risk of contamination of the operator. Also, the discharge of water is inadequate because this valve does not optimally ensure the admission of air to replace the discharged water.

U.S. Pat. No. 5,362,389 discloses another fuel filter assembly in which a valve is again provided at the lower end of the housing. This is also a manually operable valve, which is configured in such a way that air is automatically admitted when the water is discharged. This filter has the drawback, however, that manual handling is required.

### SUMMARY OF THE INVENTION

It is therefore an object of the invention to provide an improved fuel filter with a water discharge.

Another object of the invention is to provide a fuel filter with an air supply valve which does not require manual operation or handling.

A further object of the invention is to provide a fuel filter which facilitates simple and efficient discharge of separated water.

These and other objects are achieved in accordance with the present invention by providing a fuel filter comprising a housing, and a filter element disposed inside the housing, said housing having an inlet for unfiltered fuel, an outlet for filtered fuel, and a water outlet disposed at the bottom of the housing for discharging separated water which collects in a lower part of the housing, wherein the water outlet is provided with an electromagnetically operable valve which opens or closes both the water outlet and an air supply inlet.

Thus, in accordance with the invention an electromagnetically operable valve is provided, which opens and closes both an outlet for the water and an inlet for the supply of air. This separates the supply of air relative to the discharge of water, so that a definite procedure exists for making up the volume to compensate for the discharge of water.

A further refinement of the invention provides that when the valve is opened, first the water outlet is opened and subsequently i.e. with a certain time delay, the air inlet is opened. As a result any internal pressure can be released through the water outlet, and liquid is prevented from escaping through the air inlet.

In accordance with another refinement of the invention, when the water outlet opening is closed, first the air inlet is closed and subsequently the water outlet. This means, in turn, that no liquid can penetrate into the air inlet.

In one advantageous embodiment of the electromagnetically operable valve or the electromagnetic device, a stationary coil is provided within which an axially displaceable core is disposed. This core, which is configured like a piston or an armature, carries a valve seal at one end, such that the valve seal opens or closes the water outlet.

In another embodiment of the electromagnetic device, an additional valve seat is arranged on the core. This additional valve seat, however, has a certain axial mobility in relation to the core. As a result, the air supply is opened with a time delay during the opening process and is closed more rapidly when the discharge of water from the fuel filter is interrupted.

In yet another embodiment of the invention, the air supply opening is provided with a pipe extending into the interior of the filter housing. This pipe has an approximately 180° curved deflection at the upper end. The pipe is preferably made of a water-repellant material to prevent the liquid from penetrating into the pipe.

In a further embodiment of the invention, a water sensor is provided to generate a signal to control the electromagnetic valve.

The water outlet is equipped with a screen filter, a bag filter or the like to prevent dirt particles from being introduced into the valve arrangement. Advantageously, the electromagnetic valve is a module which can be adapted to a fuel filter housing.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawing figures, in which:

FIG. 1 is a cross sectional view of a fuel filter according to the invention, and

FIG. 2 is a detail representation of an electromagnetically operable valve for use in the filter of the invention.

### DETAILED DESCRIPTION OF PREFERRED EMBODIMENTS

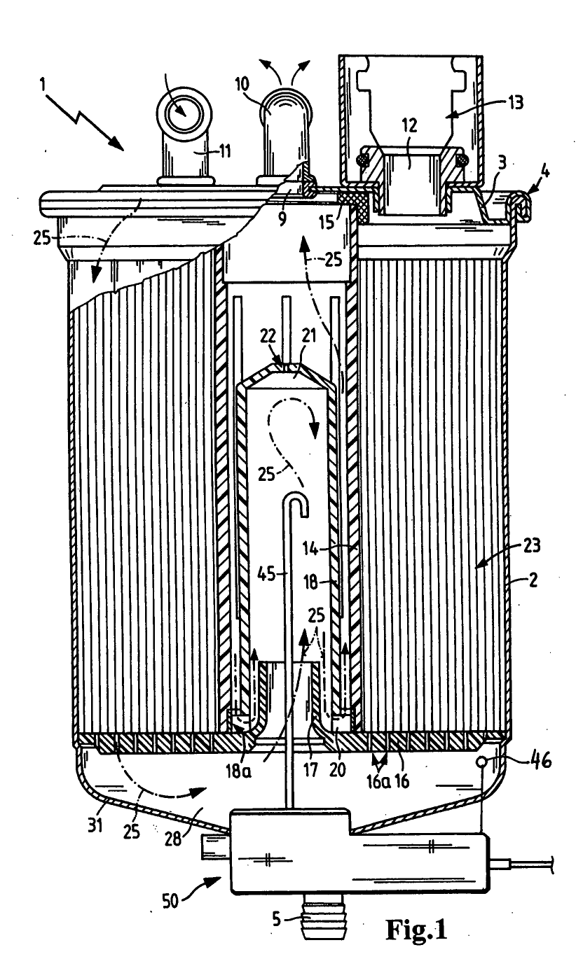

FIG. 1 shows a filter assembly 1 in cross section. Filter assembly 1 is comprised of a filter housing 2, which is made of thin sheet metal, and a housing cover 3, which is likewise made of thin sheet metal and is sealingly joined to the filter housing 2 at a housing edge 4. A water outlet 5 is provided at the bottom of the filter housing 2.

A central outlet opening 9 is provided in the housing cover 3, and an outlet connection 10 is inserted in the outlet opening 9 so as to form a tight seal. Offset from the outlet connection 10, an inlet connection 11 is provided, which is inserted into an inlet opening in the housing cover 3.

The housing cover 3 further has a return opening 12 into which a mounting device 13 is inserted. Through the return opening 12 fuel is returned into a fuel tank (not shown).

In the center of the housing cover 3 there is a downwardly extending outlet pipe 14 made, e.g., of synthetic resin material, which extends from the region around the outlet opening 9 almost to the underside of the filter housing 2. At the top the outlet pipe 14 is tightly connected to the housing cover 3 by a seal 15.

At the bottom of the outlet pipe 14 there is a perforated bottom disk 16, which is shaped at its center into a collection funnel 17, which extends into the interior of the outlet pipe 14. Between the collection funnel 17 and the outlet pipe 14, there is a plastic pipe 18, which is closed at the top. The top of pipe 18 is formed into a collection dome 21 in which a nozzle opening 22 is formed.

In operation of the filter, liquid fuel enters through the inlet connection 11 into the interior of the filter housing 2. This creates a fluid stream 25. The fluid stream 25 passes through the filter element 23 and the perforations 16a in the bottom disk 16. After exiting from the bottom disk 16, the fluid stream 25 is diverted on the underside of the filter housing 2. This region of the filter housing 2 provides a deflection region 28 in which water contained in the fluid stream 25 is separated from the fuel component. The specific gravity of the fuel is less than that of the water contained in the fuel, and after having been collected the fuel passes though the collection funnel 17 into the interior of the pipe 18. The fuel stream 25 flows upwardly inside the pipe 18, turns downwardly in the region of the collection dome 21 and flows out in downward direction through the region between the collection funnel 17 and the pipe 18. The fluid stream 25 passes through the gap 20 between the locking feet 18a around the lower edge of the pipe 18 and upwardly between the outside of the pipe 18 and the inside of the outlet pipe 14. At the top of the outlet pipe 14 the fuel flows out through the outlet connection 10.

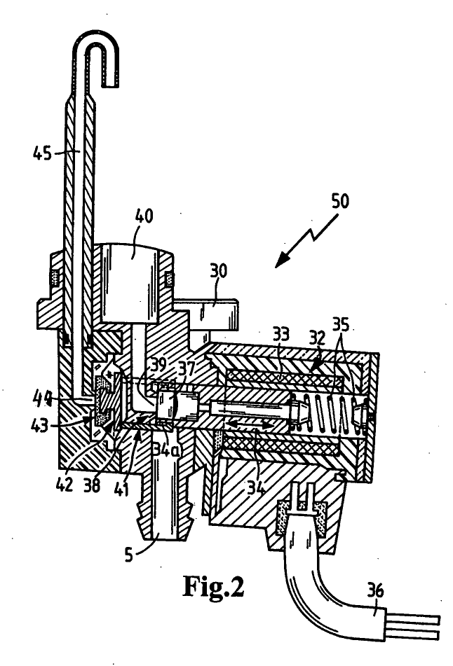

FIG. 2 shows a sectional view of the electromagnetically operable valve 50. This valve comprises a valve housing 30, which can be screwed, snapped or adhesively bonded to the bottom 31 of the filter housing 2 (see FIG. 1). An electromagnet 32 is arranged within valve housing 30. Electromagnet 32 comprises a coil 33, within which an axially displaceable core 34 is arranged. The right side of core 34 is biased toward the left in the drawing by the pressure of a compression spring 35. This compression spring 35 applies a force in the direction of the opposite end of the core 34.

Coil 33 is supplied with power through an electrical connection 36. The core 34 carries a valve plate 37, which is oriented toward with a valve seat 38. The valve plate closes the opening 39, through which when the valve is open fluid can flow from the upper collection opening 40 downwardly to the outlet 5.

On the core 34, in the region of the valve plate 37, three drive rods 41 are disposed. These drive rods 41 are connected to an additional valve plate 42, which is provided with an elastomer coating 43. The elastomer seals the opening 44, which serves to supply air from the environment into the riser tube 45 (see FIG. 1). The drive rods 41 are guided in grooves 34a along the core 34 in such a way that when the core 34 moves against the action of the compression spring 35 the valve plate 42 is not displaced until the core has traveled a certain distance, thus forming a delay path a few millimeters in length.

In the illustrated embodiment, both the water outlet opening 5 for discharging water which collects in the lower region of the fuel filter and the inlet opening 44 for the air supply are closed. If the core 34 is displaced toward the right, the opening 39 is opened first and the opening 44 thereafter with a certain delay. When opening 39 is open, water contained in the fuel filter can be discharged through water outlet 5. At the same time, air can flow into the filter through opening 44 and riser tube 45.

If desired, a water sensor 46 (see FIG. 1) can be provided to control the operation of the electromagnetically operated valve 50 to assure that accumulated water is discharged from the fuel filter 1.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A fuel filter comprising a housing, and a filter element disposed inside the housing, said housing having an inlet for unfiltered fuel, an outlet for filtered fuel, and a water outlet disposed at the bottom of the housing for discharging separated water which collects in a lower part of the housing, wherein the water outlet is provided with an electromagnetically actuable valve which opens or closes both the water outlet and an air supply inlet.

2. A fuel filter according to claim 1, wherein when the electromagnetic valve is actuated to open the water outlet and the air supply inlet, the water outlet opens first and then the air supply inlet opens subsequently after a time delay.

3. A fuel filter according to claim 1, wherein when the electromagnetic valve is actuated to close the water outlet and the air supply inlet, the air supply inlet closes first and then the water outlet closes subsequently after a time delay.

4. A fuel filter according to claim 1, wherein the electromagnetic valve comprises a stationary coil and an axially displaceable core arranged within the coil, said core carrying a valve seal on at least on one end for closing the water outlet.

5. A fuel filter according to claim 4, further comprising an additional valve seat disposed on said core with an axial bearing clearance for closing the air supply opening.

6. A fuel filter according to claim 1, wherein the air supply opening is connected to an upwardly extending pipe, said pipe having an approximately 180° deflection at its upper end.

7. A fuel filter according to claim 6, wherein said pipe is made of a water-repellant material.

8. A fuel filter according to claim 1, further comprising a water sensor in said housing for sensing accumulated water and emitting a signal for controlling the electromagnetic valve.

9. A fuel filter according to claim 1, wherein the water outlet is equipped with a screen filter to prevent dirt particles from entering the valve through the water outlet.

10. A fuel filter according to claim 1, wherein the electromagnetic valve is constructed as a module which fits the filter housing.
